(19) United States
(12) Patent Application Publication
(10) Pub. No.: US 2025/0266524 A1
(43) Pub. Date: Aug. 21, 2025

(54) BATTERY MODULE ASSEMBLY AND A METHOD OF ASSEMBLING SAME

(71) Applicants: HYUNDAI MOTOR COMPANY, Seoul (KR); KIA CORPORATION, Seoul (KR)

(72) Inventors: Jun Ho Suh, Gwacheon-si (KR); June Ho Lee, Goheung-gun (KR); Yoon Hyuk Kang, Seoul (KR); Hyun Woo Yoon, Gimpo-si (KR)

(73) Assignees: HYUNDAI MOTOR COMPANY, Seoul (KR); KIA CORPORATION, Seoul (KR)

(21) Appl. No.: 18/927,016

(22) Filed: Oct. 25, 2024

(30) Foreign Application Priority Data
Feb. 15, 2024 (KR) 10-2024-0021649

(51) Int. Cl. H01M 10/613; H01M 10/625; H01M 10/6554; H01M 50/276; H01M 50/505

(52) U.S. Cl. CPC H01M 10/613; H01M 10/625; H01M 10/6554; H01M 50/276; H01M 50/505; H01M 2220/20

(57) ABSTRACT

A battery module assembly includes: a battery module formed by staking a plurality of battery cells that respectively include electrode tabs, a cooling plate positioned adjacent to the battery module, and at least one bus bar positioned on a lateral surface of the battery module and electrically connecting the plurality of battery cells to each other. and the battery module also includes a sensing cover positioned to be spaced a predetermined distance from the bus bar and covering the battery module. In particular, a heat dissipation layer is formed between the bus bar and the sensing cover, and the heat dissipation layer is positioned in contact with the cooling plate and dissipates heat occurring in the battery module and the bus bar.

### CROSS-REFERENCE TO RELATED APPLICATION

This application claims under 35 U.S.C. § 119(a) the benefit of and priority to Korean Patent Application No. 10-2024-0021649, filed on Feb. 15, 2024, the entire contents of which are incorporated herein by reference.

### BACKGROUND

### (a) Technical Field

The present disclosure relates to a battery module assembly and a method of assembling the battery module assembly.

### (b) Background Art

Electrified vehicles include: electric vehicles (EVs) that drive by powering a drive motor, hybrid electric vehicles (HEVs) that drive using both an engine and a drive motor, and fuel cell electric vehicles (FCEVs) that drive by powering a motor with electricity generated in a fuel battery.

The electric vehicle includes a drive motor for driving the electric vehicle itself and a battery as an electricity storage mean for supplying electricity to the drive motor. Examples of the battery include well-known nickel-hydrogen batteries and lithium polymer-based batteries.

This battery is configured with a battery pack formed by connecting a plurality of battery cells in serial or in parallel. The battery pack is configured to employ a structure of coupling a PCB including battery cells and a protection circuit module (PCM).

Specifically, a battery module assembly is configured using a structure that assembles multiple battery cells. A cell stack-up assembly is configured by stacking the multiple battery cells in one direction. The movement of the cell stack-up assembly resulting from stacking the battery cells in one direction is restricted by a plate surrounding the cell stack-up assembly or by frames, and thus the cell stack-up assembly is bound, and its movement is restricted. The battery module assembly is configured in this manner.

The battery module assembly is formed to employ a structure in which a cell end portion is exposed within the battery pack and in which a module is assembled using the cell end portion. The battery module assembly is configured to employ a structure in which, for cooling, the cooling plate is installed under the battery pack, thereby lowering the temperature of heat occurring in the battery pack.

This battery module assembly does not employ a structure in which a lower end portion of the battery pack and the cooling plate come into direct contact with each other, thereby lowering the temperature of heat. Instead, the temperature of the battery pack is lowered using a heat dissipation layer constituting a cooling flow path. Therefore, a problem arises in that only the temperature of the lower end portion of the battery pack is locally lowered, failing to lower the temperature of the entire battery module assembly.

In addition, the battery module assembly is manufactured by performing a process of stacking the battery cells and assembling a through-bolt in the direction of a cell tab. Heat occurring in the battery module assembly is not effectively lowered due to the through-bolt. A space for installing the cooling flow path positioned in a lower end portion of the battery module assembly cannot be expanded and thus the cooling efficiency of the battery module assembly decreases.

The statements in this section merely provide background information related to the present disclosure and may not constitute prior art.

### SUMMARY

One object of the present disclosure, which is contrived to address the above-mentioned object, is to provide a battery module assembly capable of lowering the temperature of an entire battery module assembly in such a manner that prevents any deviation in temperature of heat occurring in the battery module assembly itself.

Another object of the present disclosure is to provide a battery module assembly capable of improving its cooling efficiency and efficiency managing its temperature.

The present disclosure is not limited to the above-mentioned objects. An object not mentioned above could be clearly understandable by embodiments of the present disclosure in the following detailed description. In addition, the objects of the present disclosure can be accomplished by limitations recited in the claims or combination thereof.

The battery module assembly for accomplishing the above-described objects of the present disclosure has the following configurations.

According to one aspect of the present disclosure, a battery module assembly includes: a battery module formed by staking a plurality of battery cells, including electrode tabs, respectively; a cooling plate positioned adjacent to the battery module; at least one bus bar positioned on a lateral surface of the battery module and electrically connecting the plurality of battery cells to each other; and a sensing cover positioned to be spaced a predetermined distance from the at least one bus bar and covering the battery module. In particular, a heat dissipation layer is formed between the at least one bus bar and the sensing cover, and the heat dissipation layer is positioned in contact with the cooling plate and dissipates heat occurring in the battery module and the at least one bus bar.

In the battery module assembly, the cooling plate may be positioned on the bottom surface of the battery module.

In the battery module assembly, the sensing cover may come into contact with the heat dissipation layer, and the at least one bus bar may be positioned in contact with the heat dissipation layer.

In the battery module assembly, the sensing cover may be manufactured of one of the following materials with thermal conductivity: aluminum, copper, or silver.

In the battery module assembly, the heat dissipation layer may be formed of a thermal interface material (TIM).

In the battery module assembly, the heat dissipation layer may be formed of a metal material with thermal conductivity.

In the battery module assembly, the cooling plate may absorb heat occurring in the battery module using the sensing cover and the heat dissipation layer that are in contact with the cooling plate.

In the battery module assembly, the battery module and the sensing cover may be arranged to be spaced a predetermined distance apart from each other, a guide hole may be formed in a space, resulting from the spacing, and the liquid-state heat dissipation layer may be injected in the guide hole.

In the battery module assembly, the sensing cover may include a rib formed in the direction of the cooling plate, wherein the cooling plate may be seated on the rib.

The battery module assembly may further include an injection plate positioned between the battery module and the sensing cover to prevent the liquid-state heat dissipation layer from leaking to the battery cell.

In the battery module assembly, one or more battery module assemblies are arranged in a first direction and a second direction, and a through-bolt may be positioned between the battery module assemblies positioned in the second direction.

In the battery module assembly, the first direction may be a lengthwise direction of the plurality of battery cells, and the second direction may be a direction in which the battery cells are stacked.

In the battery module assembly, the at least one bus bar may include a peripheral bus bar for regulating a position of the heat dissipation layer, and the peripheral bus bar is formed in the shape of the Korean letter “ [symbol] ” or “ [symbol] ” in order to prevent flowing of the liquid-state heat dissipation layer.

A method of assembling the battery module assembly for accomplishing the above-described objects of the present disclosure has the following configurations.

According to another aspect of the present disclosure, a method of assembling a battery module assembly includes: stacking a plurality of battery cells having electrode tabs; connecting, the at least one bus bar, the electrode tabs of the plurality of battery cells, thereby configuring a battery module; attaching a cooling plate to the battery module; arranging a sensing cover on front and rear surfaces of the battery module; arranging the battery module and the sensing cover to be spaced a predetermined distance apart from each other; injecting a liquid-state heat dissipation layer into a space formed between the battery module and the sensing cover; and cooling the battery module and the at least one bus bar.

In the method, the cooling plate may be attached to the bottom surface of the battery module.

In the method, an injection plate may be positioned between the battery module and the sensing cover, and, using the injection plate, a position of the liquid-state heat dissipation layer may be regulated in such a manner that the liquid-state heat dissipation layer does not leak.

In the method, the connecting of the plurality of battery cells and the configuring of the battery module may further include: assembling an injection plate to front surfaces and rear surfaces of the plurality of battery cells that are stacked; and pressing against the injection plate to the front surfaces and the rear surfaces of the plurality of battery cells.

In the method, in the arranging of the battery module and the sensing cover and the injecting of the liquid-state heat dissipation layer, the liquid-state heat dissipation layer may be injected using a guide hole.

In the method, the heat dissipation layer may be formed of a thermal interface material (TIM), the cooling plate is formed of a metal material with thermal conductivity, and the sensing cover is manufactured of one of the following materials with thermal conductivity: aluminum, copper, or silver.

According to the present disclosure, the following advantageous effects are obtained through the embodiments described above and through configurations, combinations, and application-based relationships that are described below.

According to the present disclosure, the temperature of the entire battery module assembly can be lowered in such a manner that a deviation in the temperature of heat occurring in the battery module assembly itself.

In addition, according to the present disclosure, the cooling efficiency of the battery module assembly can be improved, and the temperate thereof can be efficiently managed.

### BRIEF DESCRIPTION OF THE DRAWINGS

The above and other features of the present disclosure are now described in detail with reference to certain examples thereof illustrated in the accompanying drawings which are given herein below by way of illustration only, and thus are not limitative of the present disclosure, and wherein:

FIG. 1 is a cross-sectional view illustrating a cross section of a battery module assembly according to an embodiment of the present disclosure;

FIG. 2 is a perspective view illustrating one portion of the battery module assembly according to the present disclosure as installed in a vehicle;

FIG. 3 is a perspective view illustrating the battery module assembly according to the present disclosure;

FIG. 4 is a cross-sectional view taken along line B-B on FIG. 3;

FIG. 5 is a cross-sectional view taken along line C-C on FIG. 3;

FIG. 6 is a cross-sectional view illustrating a location of a heat dissipation layer in the battery module assembly according to an embodiment of the present disclosure;

FIG. 7 is a view illustrating the battery module assembly according to the present disclosure, as seen from the top; and

FIG. 8 is a block diagram sequentially illustrating steps of a method of assembling the battery module assembly according to an embodiment of the present disclosure.

### DETAILED DESCRIPTION

Embodiments of the present disclosure are described in more detail below with reference to the accompanying drawings. The embodiments of the present disclosure may be modified in various forms, and the scope of the present disclosure should not be interpreted as being limited to the embodiments described below. The embodiments are described in sufficient detail to enable a person of ordinary skill in the art to make and use the present disclosure without undue experimentation.

The term “unit,” “module,” or the like, which is used throughout the specification, means an individual component that performs at least one function or operation and may be realized in hardware, software, or a combination of both.

The terms used in the present specification are only for describing a specific embodiment and are not intended to impose any limitation on the specific embodiment. A noun in singular form has the same meaning as when used in its plural form, unless it has a different meaning in context.

When a component, device, element, or the like of the present disclosure is described as having a purpose or performing an operation, function, or the like, the component, device, or element should be considered herein as being “configured to” meet that purpose or to perform that operation or function.

In addition, in order to distinguish among constituent elements that have the same name, the terms first, second, and so on are used throughout the present specification. In the following description, no limitation is necessarily imposed to the order of the terms.

The embodiments are described in detail below with reference to the accompanying drawings. The same reference numbers are assigned to the same constituent elements or to constituent elements that correspond to each other. The same description thereof is not repeated.

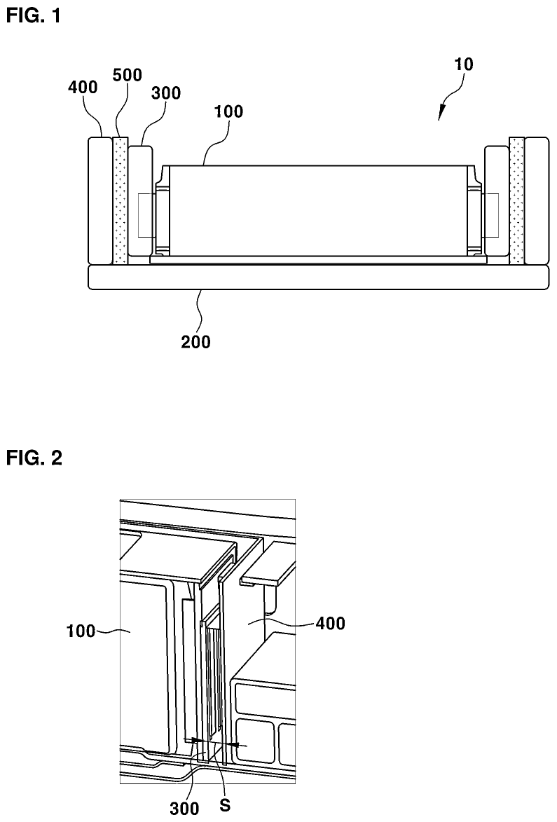

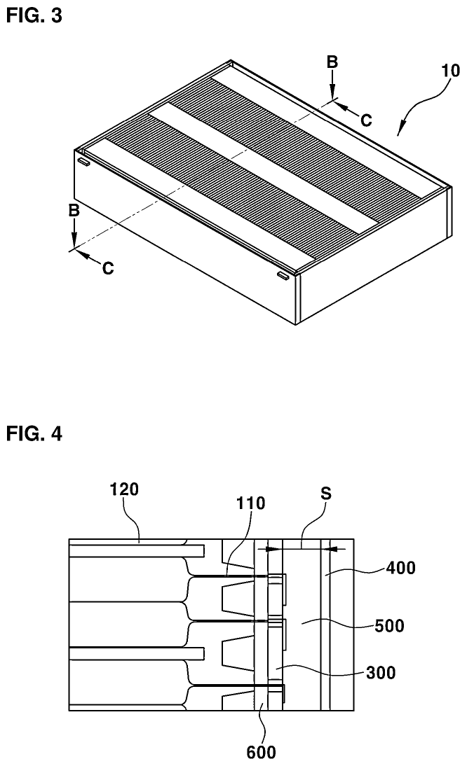

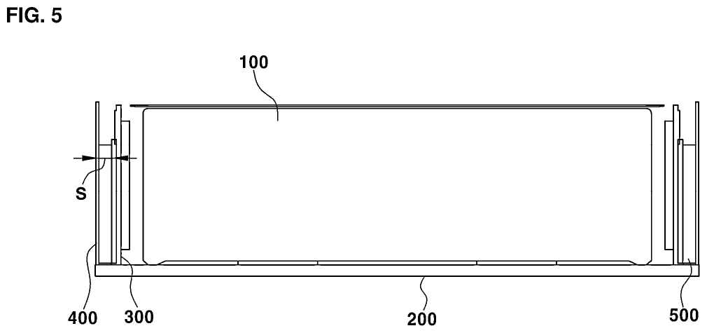

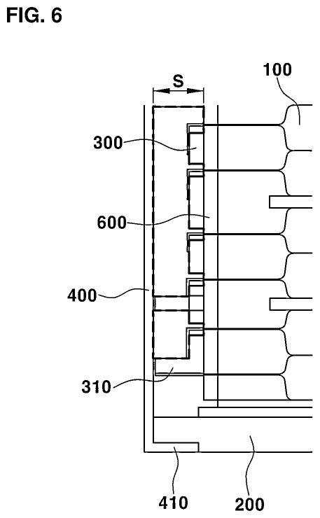

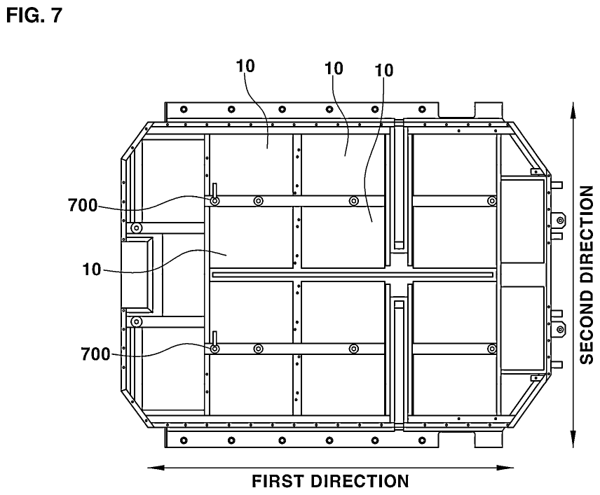

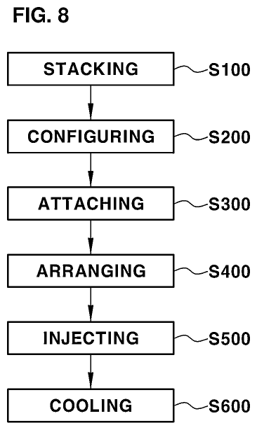

FIG. 1 is a cross-sectional view illustrating a cross section of a battery module assembly according to an embodiment of the present disclosure. FIG. 2 is a perspective view illustrating one portion of the battery module assembly according to the present disclosure as installed in a vehicle. FIG. 3 is a perspective view illustrating the battery module assembly according to the present disclosure. FIG. 4 is a cross-sectional view taken along line B-B on FIG. 3. FIG. 5 is a cross-sectional view taken along line C-C on FIG. 3. FIG. 6 is a cross-sectional view specifically illustrating a position of a heat dissipation layer in the battery module assembly according to an embodiment of the present disclosure. FIG. 7 is a view illustrating the battery module assembly, according to the present disclosure, as seen from the top. FIG. 8 is a block diagram sequentially illustrating steps of a method of assembling the battery module assembly according to an embodiment of the present disclosure.

With reference to FIGS. 1 to 6, a battery module assembly 10 according to a first embodiment of the present disclosure includes: a battery module 100 formed by staking a plurality of battery cells 120 each including an electrode tab 110; a cooling plate 200 positioned on a bottom surface of the battery module 100; and a bus bar 300 positioned on a lateral surface of the battery module 100 and electrically connecting the plurality of battery cells 120 to each other. The battery module 100 further includes a sensing cover 400 positioned to be spaced a predetermined distance from the bus bar 300 and covering the battery module 100. The battery module assembly 10 employs a structure in which a heat dissipation layer 500 is formed into a space “S”, resulting from the spacing, between the bus bar 300 and the sensing cover 400.

The battery module 100 of the battery module assembly 10 according to the first embodiment of the present disclosure is configured as a stack-up assembly formed by stacking the plurality of battery cells 120 in one direction. The battery cell 120 may have the shape of a cylinder, pouch, square, or the like. The number of the battery cells 120 that constitute one cell stack-up assembly may fall within a range suitably selected by a person of ordinary skill in the art. In addition, a cell stack-up assembly may be formed as a group resulting from stacking the plurality of battery cells 120 according to the present disclosure in a single row. In addition, the plurality of battery cells 120 according to the present disclosure are connected to the electrode tabs 110, respectively. Thus, the plurality of battery cells 120 are configured to have an electrical coupling structure. In addition, the battery cell 120 is charged with electric power supplied from the outside and is discharged by supplying the stored electric power to the outside.

According to the present disclosure, the battery module 100 is described as being formed by the configuration of the battery cells 120 and the electrode tabs 110. However, a secondary cell may be configured with various structures of the battery module 100 that is manufactured by a person of ordinary skill in the art to which the present disclosure pertains. A secondary battery that undergoes repeated charging or discharging through electrochemical reactions is employed as the battery module 100 according to the present disclosure. Furthermore, a high-capacity secondary battery may be employed suitably for use in driving a vehicle.

The cooling plate 200 of the battery module assembly 10 according to the first embodiment of the present disclosure is positioned on the bottom surface of the battery module 100, comes into contact with the sensing cover 400 and the heat dissipation layer 500, which are described below, and serves to absorb and dissipate heat that occurs in the battery module 100. Specifically, the cooling plate 200 of the battery module assembly 10 may be made of a metal material with high thermal conductivity to efficiently dissipate heat that occurs in the battery module 100. For example, the cooling plate 200 may be formed of a metal material with high thermal conductivity, such as aluminum or copper, and may employ various shapes, such as a cooling fin and a cooling plate. For example, the cooling plate 200 may employ any shape or material, as long as it can effectively maximize transfer of heat that occurs in the battery module 100.

In addition, the cooling plate 200 according to the present disclosure can be manufactured in the shape of a plate with an area that is expanded to come into contact with the sensing cover 400 and the heat dissipation layer 500, thereby increasing cooling efficiency. The cooling plate 200 according to the present disclosure is described as employing the shape of a plate, but it is also possible that the cooling plate 200 has a cooling flow path. Furthermore, it is also possible that the cooling plate 200 employs a structure in which a cooling line through which a coolant flows is provided inside the cooling plate 200 and in which the coolant is used as a refrigerant.

In another embodiment, the bus bar 300 of the battery module assembly 10 is connected to each of the electrode tabs 110 and electrically connects the plurality of battery cells 120 and a substrate (not illustrated) to each other. In addition, the bus bar 300 according to the present disclosure, shaped to be coupled to each of the positive and negative electrodes of the battery module 100 at both lateral sides of the battery cell 120 is provided. The bottom surface of the bus bar 300 may be arranged to be positioned adjacent to the cooling plate 200, but not in contact therewith. In addition, one or more bus bar 300 are arranged. Furthermore, the bus bar 300 adjacent to the heat dissipation layer 500 is a peripheral bus bar 310 formed in the shape of the Korean letter “ [symbol] ” or “ [symbol] ” in order to prevent the flow of the liquid-state heat dissipation layer 500 and regulate a position of the heat dissipation layer 500. Specifically, the peripheral bus bar 310 is positioned adjacent to the heat dissipation layer 500 among one or more bus bars 300. The peripheral bus bar 310 is formed in such a manner as to have a greater area than the other bus bars 300. The peripheral bus bar 310 may be formed in the shape of the Korean letter “ [symbol] ” or “ [symbol] ” in order to prevent the flow of the liquid-state heat dissipation layer 500.

The sensing cover 400 of the battery module assembly 10 according to the first embodiment of the present disclosure is positioned in such a manner that the bottom surface thereof is in contact with the cooling plate 200. Furthermore, the sensing cover 400 is configured in such a manner that a lateral surface thereof is spaced a predetermined distance apart from the bus bar 300 and is in contact with the heat dissipation layer 500. Specifically, the sensing cover 400 may be mad of a material with thermal conductivity in order to effectively dissipate heat occurring in the battery module 100 and to significantly lower the temperature of the battery module 100. Examples of the material include aluminum, copper, and silver.

In addition, the sensing cover 400 according to the present disclosure may also be used to protect the battery module 100. Accordingly, the sensing cover 400 may be manufactured in the shape that is appropriately designed by a person of ordinary skill in the art according to the suitable shape and size of the battery module 100.

In addition, a rib 410 may be formed in the direction of the cooling plate 200 on the sensing cover 400 according to the present disclosure. The sensing cover 400 may be configured to employ a structure in which the cooling plate 200 is seated on the rib 410.

With reference to FIG. 6, the cooling plate 200 may be arranged to come into contact with the rib 410 on the sensing cover 400. The reason for forming the rib 410 on the sensing cover 400 is to stably bring the cooling plate 200 into contact with the sensing cover 400 and to expand an area of the cooling plate 200 that comes into contact with the cooling plate 200. In addition, the rib 410 on the sensing cover 400 increases the area, in contact with the cooling plate 200, of the sensing cover 400, thereby effectively lowering heat that occurs in the battery module 100.

The sensing cover 400 according to the present disclosure is made of a material with thermal conductivity, the bottom surface thereof comes into contact with the cooling plate 200, and the lateral surface thereof comes into contact with the heat dissipation layer 500. Accordingly, heat that occurs in the battery module 100 can be effectively dissipated.

The heat dissipation layer 500 of the battery module assembly 10 according to the first embodiment of the present disclosure is positioned in the space “S” between the bus bar 300 and the sensing cover 400. The heat dissipation layer 500 is in contact with the cooling plate 200 so that the heat dissipation layer 500 serves to dissipate heat occurring in the battery module 100 and the bus bar 300.

Specifically, the heat dissipation layer 500 of the battery module assembly 10 according to the present disclosure is formed of a thermal interface material (TIM). The heat dissipation layer 500 is arranged in such a manner that one surface thereof can be attached to the sensing cover 400 and that a different surface opposite to the one surface can come into contact with the bus bar 300.

FIG. 7 is a view illustrating the battery module assembly according to the present disclosure, when viewed from the top. With reference to FIG. 7, one or more battery module assemblies 10 according to the present disclosure may be configured and may be arranged in a first direction and a second direction.

At this point, the first direction is the lengthwise direction of a battery cell, and the second direction is a direction in which the battery cells are stacked. In the related art, a through-bolt 700 is assembled in the direction of the bus bar 300 of the battery module assembly 10 or in the direction of the electrode tabs 110. However, in one embodiment of the present disclosure, the through-bolt 700 is assembled between the battery module assemblies 10. In the related art, the position of the through-bolt 700 does not effectively reduce heat that occurs in the bus bar 300 or the electrode tabs 110. However, the assembling of the through-bolt 700 between the battery module assemblies 10 according to the present disclosure can effectively reduce heat that occurs in the battery module assembly 10. In addition, according to the present disclosure, the through-bolt 700 is used to establish connection to the battery module assembly 10. Accordingly, the position of the through-bolt 700 can expand a space for installing the cooling plate 200 positioned below the battery module assembly 10 or for installing the cooling flow path. With this simple structure that changes the position of the through-bolt 700, heat management for the battery module assembly 10 capable of lowering heat occurring in the battery module assembly 10 can be realized.

The heat dissipation layer 500 is positioned in the space S, resulting from the spacing, between the bus bar 300 and the sensing cover 400. A guide hole (not illustrated) is formed in the space S created by the spacing. The liquid-state heat dissipation layer 500 is injected into the guide hole. In addition, the cooling plate 200 is arranged on the bottom surface of the space S, resulting from the spacing, in such a manner that the liquid-state heat dissipation layer 500 does not flow.

A method of assembling the battery module assembly 10 by injecting the liquid-state heat dissipation layer 500 through the guide hole when assembling the battery cell 120 of the stacking-resulting battery module 100 and the sensing cover 400 is described in detail below.

FIG. 8 is a block diagram illustrating a method of manufacturing the battery module assembly according to an embodiment of the present disclosure.

With reference to FIG. 8, steps of the method of manufacturing the battery module assembly 10 are sequentially described.

For the battery module assembly 10, the plurality of battery cells 120 are stacked in one direction (a step S100).

In a step S200, the electrode tabs are connected to the plurality of battery cells 120, respectively. The bus bars 300 that electrically connects the battery cells 120 to each other in a direction in which each of the electrode tabs 110 protrudes is assembled. The bus bars 300 may be coupled to both lateral surfaces, respectively, of the plurality of battery cells 120. The battery module 100 may be formed by electrically connecting the electrode tabs 110 and the bus bar 300 to the battery cell 120.

In a step S300, the cooling plate 200 is attached to the bottom surface of the battery module 100. The cooling plate 200 is attached to the battery module 100 in a manner that comes into close contact therewith, in order to cool the battery module 100 or lower the temperature thereof. In addition, the expansion of the area of the cooling plate 200, which is in contact with the battery module 100, increases the area of the cooling plate 200, to which the battery module 100 transfers heat. In other words, by expanding the contact area with the battery module (100), the heat transfer area to the battery module (100) increases. Therefore, the battery module 100 can be quickly cooled, or the temperature thereof can be effectively lowered.

Subsequently, in a step S400, the sensing cover 400 is positioned on the front and rear surfaces of the battery module 100 and is arranged to be a predetermined distance apart from the battery module 100. In addition, the cooling plate 200 is attached on the bottom surface of the sensing cover 400. When the area of the sensing cover 400, which comes into contact with the cooling plate 200, is expanded and is brought into close contact with the cooling plate 200, the area of the sensing cover 400, to which heat is transferred, is also increased, thereby facilitating quick cooling of the battery module 100 and lowering of the temperature thereof. Therefore, it is desired to form the close contact between the sensing cover 400 and the cooling plate 200 and to expand the close contact area.

Subsequently, in a step S500, the liquid-state heat dissipation layer 500 is injected into the space S, resulting from the spacing, between the battery module 100 and the sensing cover 400. In the space “S” positioned between the battery module 100 and the sensing cover 400, the liquid-state heat dissipation layer 500 is injected through the guide hole in such a manner that the liquid-state heat dissipation layer 500 does not flow to another module. The cooling plate 200 is positioned on the bottom surface of the heat dissipation layer 500, and the positions of the sensing cover 400 and the battery module 100 are regulated in such a manner that the liquid-state heat dissipation layer 500 does not leak. Thus, the heat dissipation layer 500 may be stably positioned in the space S.

In another embodiment, the battery module assembly 10 may further include an injection plate 600 positioned in the space S, which is positioned between the sensing cover 400 and the battery module 100, in such a manner that the liquid-state heat dissipation layer 500 is stably injected. The injection plate 600 is positioned adjacent to the battery cell 120 of the battery module 100 and serves to regulate the flow of the liquid-state heat dissipation layer 500 in such a manner that it is not injected into the battery module 100.

In a step S600, a step of cooling the battery module 100 and the bus bar 300 is performed. Specifically, the liquid-state heat dissipation layer 500 is injected, and the cooling plate 200 is driven in order to cool the heat dissipation layer 500 or lower the temperature thereof. The cooling plate 200 may employ the shape of a plate or a flow path, thereby fully cooling the battery module 100 and the bottom of the bus bar 300.

By cooling the cooling plate 200, low temperature is transferred to sensing cover 400 and the heat dissipation layer 500 that are in contact with the cooling plate 200. The material properties of the sensing cover 400 and the heat dissipation layer 500 can significantly facilitate quick temperature transfer to the bus bar 300. The cooling plate 200 in contact with the battery module 100 can also quickly lower the temperature of the battery module 100.

This coupling relationship in the battery module assembly 10 according to the present disclosure can significantly lower the temperature of the battery module 100. In addition, the battery module 100 is positioned in such a manner that the bottom surface thereof is in contact with the cooling plate 200. The sensing cover 400 and the heat dissipation layer 500 are positioned in such a manner that the bottom surfaces thereof are in contact with the cooling plate 200. Thus, a deviation in temperature that occurs within the battery module 100 can be effectively reduced. Consequently, the battery module assembly 10 capable of effectively controlling heat generation in the battery module 100 can be realized. In addition, the positioning of the heat dissipation layer 500 between the sensing cover 400 and the bus bar 300 can change the position of the through-bolt 700 assembled in the direction of a cell tab, thereby improving the cooling efficiency of the battery module assembly 10.

The present disclosure is described in detail above in an exemplary manner. In addition, the embodiments of the present disclosure are described in sufficient detail to enable a person of ordinary skill in the art to practice the present disclosure. Various modifications to, and combinations of, the embodiment of the present disclosure may be made under various conditions. Modifications or alterations would be made to the embodiments, as disclosed in the present disclosure, within the scope of the concept of the present disclosure, the scope of equivalents of the disclosed contents, and/or the scope of the technology or knowledge in the art. It is also possible that various modifications, which may be required in the field in which the present disclosure finds application, are made to the embodiments. Therefore, the embodiments, as disclosed in detail above, of the present disclosure are not intended to impose any limitation on the present disclosure. In addition, the following claims should be construed as covering other embodiments of the present disclosure as well.

What is claimed is:

1. A battery module assembly comprises:
a battery module formed by staking a plurality of battery cells, including electrode tabs, respectively;
a cooling plate positioned adjacent to the battery module;
at least one bus bar positioned on a lateral surface of the battery module and electrically connecting the plurality of battery cells to each other; and
a sensing cover positioned to be spaced a predetermined distance from the at least one bus bar and covering the battery module,
wherein a heat dissipation layer is formed between the at least one bus bar and the sensing cover, and
wherein the heat dissipation layer is positioned in contact with the cooling plate and configured to dissipate heat occurring in the battery module and the at least one bus bar.

2. The battery module assembly of claim 1, wherein the cooling plate is positioned on a bottom surface of the battery module.

3. The battery module assembly of claim 1, wherein the sensing cover comes into contact with the heat dissipation layer, and the at least one bus bar is positioned in contact with the heat dissipation layer.

4. The battery module assembly of claim 1, wherein the sensing cover is manufactured of one of the following materials with thermal conductivity: aluminum, copper, or silver.

5. The battery module assembly of claim 1, wherein the heat dissipation layer is formed of a thermal interface material (TIM).

6. The battery module assembly of claim 1, wherein the heat dissipation layer is formed of a metal material with thermal conductivity.

7. The battery module assembly of claim 1, wherein the cooling plate is configured to absorb heat occurring in the battery module using the sensing cover and the heat dissipation layer that are in contact with the cooling plate.

8. The battery module assembly of claim 1, wherein the battery module and the sensing cover are arranged to be spaced a predetermined distance apart from each other, a guide hole is formed in a space, resulting from the spacing, and the heat dissipation layer in a liquid state is injected into the guide hole.

9. The battery module assembly of claim 1, wherein the sensing cover comprises:
a rib formed in a direction of the cooling plate,
wherein the cooling plate is seated on the rib.

10. The battery module assembly of claim 1, further comprising:
an injection plate positioned between the battery module and the sensing cover to prevent the heat dissipation layer in a liquid state from leaking to the plurality of battery cells.

11. The battery module assembly of claim 1, wherein one or more battery module assemblies are arranged in a first direction and a second direction, and a through-bolt is positioned between the battery module assemblies positioned in the second direction.

12. The battery module assembly of claim 11, wherein the first direction is a lengthwise direction of the plurality of battery cells, and the second direction is a direction in which the plurality of battery cells are stacked.

13. The battery module assembly of claim 1, wherein the at least one bus bar includes a peripheral bus bar for regulating a position of the heat dissipation layer, and the peripheral bus bar is formed in a shape of a Korean letter “ [symbol] ” or “ [symbol] ” in order to prevent flowing of the heat dissipation layer in a liquid state.

14. A method of assembling a battery module assembly, the method comprising:
stacking a plurality of battery cells having electrode tabs;
connecting, by at least one bus bar, the electrode tabs of the plurality of battery cells, thereby configuring a battery module;
attaching a cooling plate to the battery module;
arranging a sensing cover on front and rear surfaces of the battery module;
arranging the battery module and the sensing cover to be spaced a predetermined distance apart from each other;
injecting a liquid-state heat dissipation layer into a space formed between the battery module and the sensing cover; and
cooling the battery module and the at least one bus bar.

15. The method of claim 14, wherein the cooling plate is attached to a bottom surface of the battery module.

16. The method of claim 14, wherein an injection plate is positioned between the battery module and the sensing cover, and, using the injection plate, a position of the liquid-state heat dissipation layer is regulated in such a manner that the liquid-state heat dissipation layer does not leak.

17. The method of claim 14, wherein the connecting of the plurality of battery cells and the configuring of the battery module further comprises:
assembling an injection plate to front surfaces and rear surfaces of the plurality of battery cells that are stacked; and
pressing against the injection plate to the front surfaces and the rear surfaces of the plurality of battery cells.

18. The method of claim 14, wherein, in the arranging of the battery module and the sensing cover and the injecting of the liquid-state heat dissipation layer, the liquid-state heat dissipation layer is injected using a guide hole.

19. The method of claim 14, wherein, the liquid-state heat dissipation layer is formed of a thermal interface material (TIM), the cooling plate is formed of a metal material with thermal conductivity, and the sensing cover is manufactured of one of the following materials with thermal conductivity: aluminum, copper, or silver.
